(19) United States
(12) Patent Application Publication
(10) Pub. No.: US 2009/0142533 A1
(43) Pub. Date: Jun. 4, 2009

(54) Adhesive film

(76) Inventor: Li-Ming Cheng, Kaohsiung City (TW)

Correspondence Address: Frenkel & Associates, P.C., Suite 330, 3975 University Drive, Fairfax, VA, 22030, US

(21) Appl. No.: 11/998,929

(22) Filed: Dec. 3, 2007

(51) Int. Cl. B32B 33/00

(52) U.S. Cl. 428/41.8

(57) ABSTRACT

An adhesive film mainly has a body which has a printed pattern layer on one side and a smooth layer on another side. The smooth layer is coated with an adhesive layer. The adhesive layer is bonded to a release paper on one side that has a concave and convex layer. When the release paper is peeled off, the adhesive layer has a convex and concave layer formed on one side due to bonding with the concave and convex layer of the release paper. The convex and concave layer has a plurality of air passages formed thereon. Thus during flat bonding process air is discharged through the air passages, and bonding result is flat and neat.

### FIELD OF THE INVENTION

The present invention relates to an adhesive film and particularly to an adhesive film that can be flatly bonded without leaving residual air bubbles and easily laid.

### BACKGROUND OF THE INVENTION

A conventional adhesive film 10 as shown in FIG. 1 commonly has a pattern layer 11 and a release paper 12 with an adhesive layer 13 interposed between them.

When in use to flatly bond the adhesive film 10 onto the surface of a glass 20, a uniform pressure has to be applied to the adhesive layer 13. As the adhesive layer 13 has a flat surface, during applying the pressure air is inescapable. Thus air bubbles 21 are easily formed and trapped between the adhesive film 10 and the surface of the glass 20. As a result an uneven bulged surface is formed on the adhesive film 10. It is unsightly. Bonding process also is tedious and time consuming (referring to FIG. 2).

### SUMMARY OF THE INVENTION

The primary object of the present invention is to provide an adhesive film that can be bonded onto a surface under pressure to provide more aesthetic appeal and does not form residual air bubbles between the adhesive film and the bonded surface during bonding process, thereby to make utilization easier.

The adhesive film according to the invention includes a body which has a pattern layer on one side and a smooth layer on another side. The smooth layer is coated with an adhesive layer. The surface of the adhesive layer is bonded to a release paper which has a concave and convex layer at one side. After both are bonded together and the release paper is peeled off, the surface of the adhesive layer is formed with a convex and concave layer containing a plurality of air passages. Thus no residual air is trapped or remained during bonding process.

In one aspect the concave and convex layer on one side of the release paper is formed longitudinally and transversely crossing each other in an array fashion with a plurality of air passages among them that communicate with one another. The air passages may also be formed circular in a mesh fashion, or a radial fashion.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a sectional view of a conventional adhesive film.

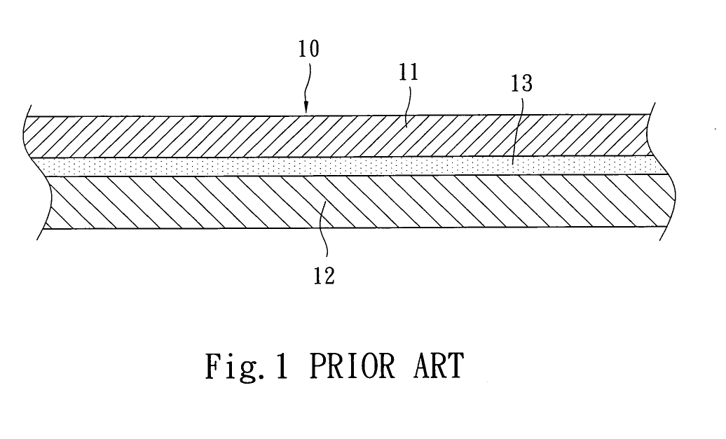

FIG. 2 is a schematic view of a conventional adhesive film bonding to the surface of glass with residual air bubbles formed thereon

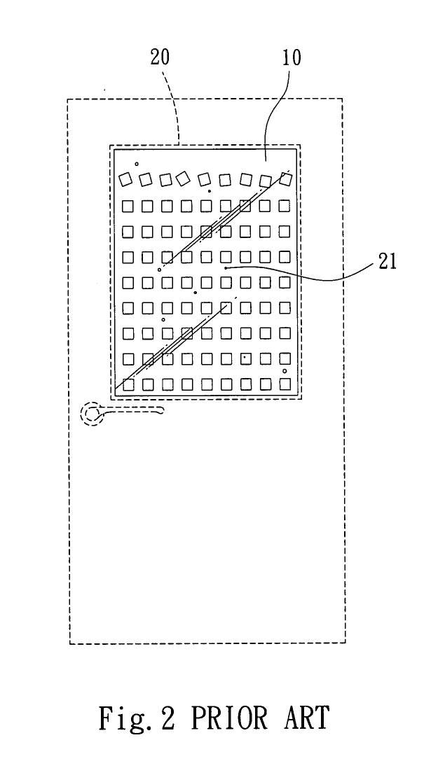

FIG. 3 is a perspective view of the adhesive film of the invention.

FIG. 4 is a sectional view of the adhesive film of the invention.

FIG. 5 is a fragmentary top view of the release paper of the invention with a longitudinal and transverse layout.

FIG. 6 is a schematic view of the invention with the release paper peeled off to be bonded to a glass.

FIG. 7 is a schematic view of the invention with the adhesive film bonding to a glass surface.

FIG. 8 is a fragmentary top view of the invention with the concave and convex layer of the release paper formed in a mesh fashion.

### DETAILED DESCRIPTION OF THE PREFERRED EMBODIMENTS

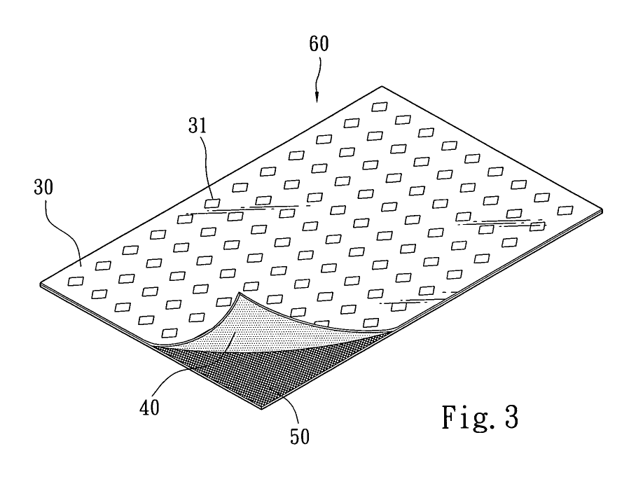

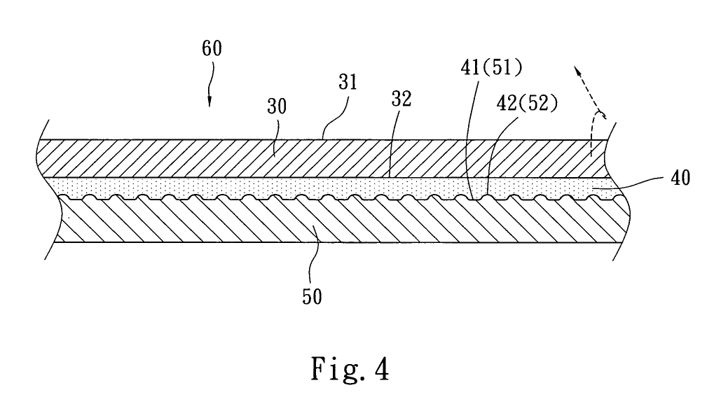

Please refer to FIGS. 3 and 4 for an embodiment of the adhesive film of the invention. The adhesive film 60 includes three layers, namely a body 30 with a first layer printed with patterns to become a pattern layer 31, a second layer which is an adhesive layer 40, and a third layer which is a release paper 50. Viewing from another perspective, the body 30 has one side printed with the patterns to become the pattern layer 31 and another side is a smooth layer 32. The adhesive layer 40 is formed on the surface of the smooth layer 32. The surface of the adhesive layer 40 is bonded to a concave and convex layer 51 of the release paper 50. When in use, the release paper 50 is peeled off, and the surface of the adhesive layer 40 forms a convex and concave layer 41 inverse to the concave and convex layer 51 of the release paper 50 that has a plurality of air passages 42 formed thereon that communicate with one another. Thus during bonding process of the adhesive film 60 no residual air bubbles are remained.

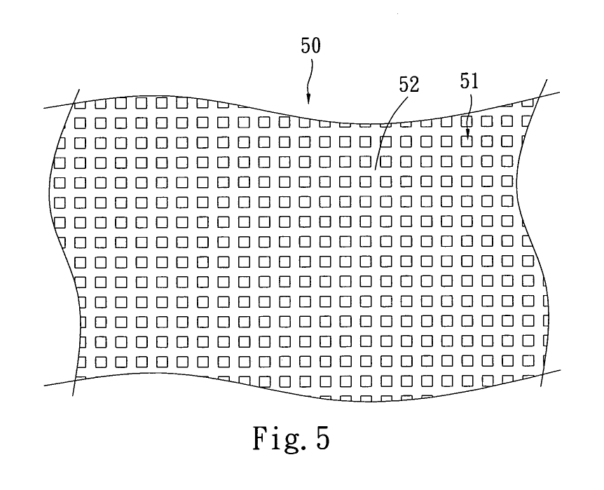

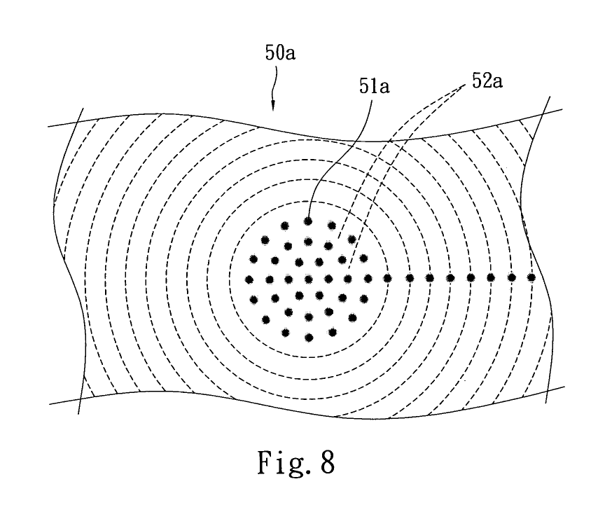

The concave and convex layer 51 on one side of the release paper 50 may be formed in a longitudinal and transverse fashion crossing each other to form a plurality of air passages 52 communicating with one another (referring to FIG. 5). The concave and convex layer 51a on the release paper 50a may also be formed in a circular fashion with mesh type air passages 52a (as shown in FIG. 8) or radial air passages (not shown in the drawings).

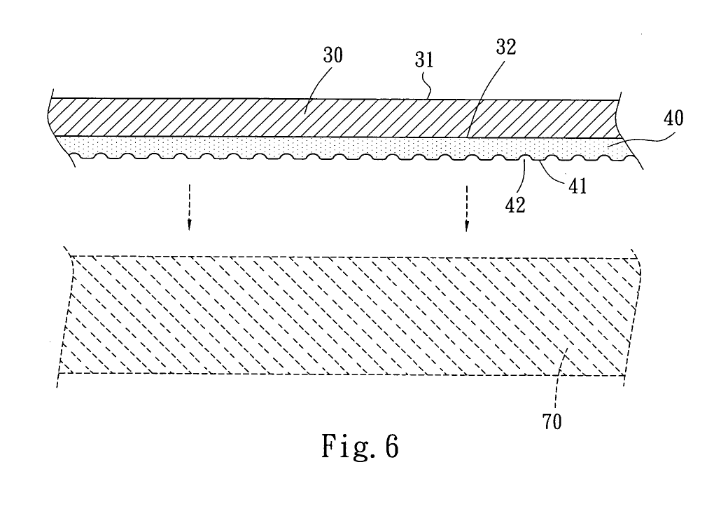

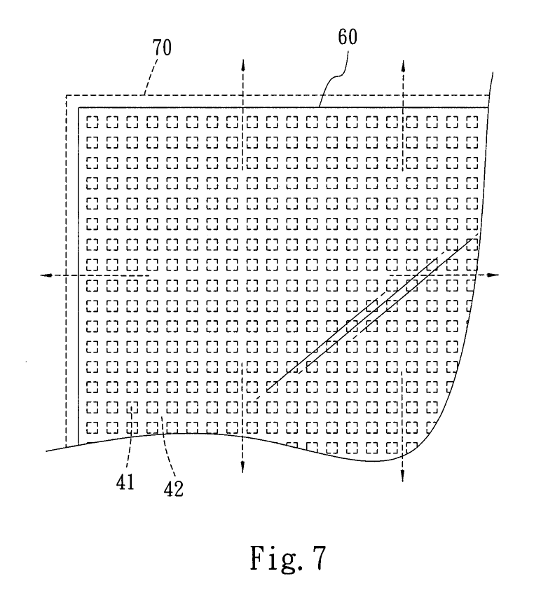

In practice, after the release paper 50 is peeled off, the adhesive layer 40 has the air passages 42 formed on the convex and concave layer 41. Therefore during bonding process of the adhesive film 60 to a glass 70, air can escape through the air passages 42 without leaving residual air bubbles between the adhesive film 60 and the glass 70 (referring to FIGS. 6 and 7). Thus a flat and neat bonding effect can be achieved.

In short, the adhesive film of the invention provides the following advantages:
Due to the adhesive layer 40 is coated on the smooth layer 32 of the adhesive film 60 and bonded to the concave and convex layer 51 of the release paper 50, after the release paper 50 is peeled off air passages 42 are formed on the inverse convex and concave layer 41. Hence during bonding to the glass 70 air is discharged through the air passages 42. And a flat and neat bonding result is formed.
Upon bonding to the concave and convex layer 51 of the release paper 50, the adhesive layer 40 has the corresponding and inverse convex and concave layer 41 formed thereon with air passages 42 to discharge air. Thus bonding to the glass 70 is flat and smoother.

What is claimed is:

1. An adhesive film, comprising:
a body which has a pattern layer on one side and a smooth layer on another side;
an adhesive layer coated on the smooth layer of the body; and
a release paper which has a concave and convex layer bonding to the adhesive layer such that the adhesive layer forms a convex and concave layer on the surface thereof after the release paper is peeled off that has a plurality of air passages formed thereon.

2. The adhesive film of claim 1, wherein the concave and convex layer of the release paper is arranged longitudinally and transversely crossing each other.

3. The adhesive film of claim 1, wherein the concave and convex layer of the release paper is arranged in a mesh fashion.

4. The adhesive film of claim 1, wherein the concave and convex layer of the release paper is arranged in a radial fashion.

5. The adhesive film of claim 1, wherein the air passages of the convex and concave layer on the adhesive layer communicate with one another.
